(19) United States
(12) Patent Application Publication
(10) Pub. No.: US 2005/0262334 A1
(43) Pub. Date: Nov. 24, 2005

(54) Computer restoration apparatus

(76) Inventor: James Scudder, Lynchburg, VA (US)

Correspondence Address: VANCE INTELLECTUAL PROPERTY, PC, 857 RODES VALLEY DR., NELLYSFORD, VA, 22958, US

(21) Appl. No.: 10/850,200

(22) Filed: May 20, 2004

(51) Int. Cl. G06F 9/00

(52) U.S. Cl. 713/1

(57) ABSTRACT

The present invention relates generally to a novel computer fitted with a switch that is capable of restoring a computer that has had an operating system or hard drive crash and the corresponding method of restoration and apparatus that is capable of restoring.

### FIELD OF THE INVENTION

The present invention relates generally to a novel computer fitted with an switch capable of restoring the computer if it has had an operating system or hard drive crash and the corresponding novel method and novel apparatus for restoring.

### BACKGROUND

In today's world, the personal computer (PC) has become an indispensable tool for most people and businesses. Unfortunately, PCs are highly vulnerable to operating system or hard drive crashes. These crashes can cause a loss of data; sometimes an entire hard drive is lost. Current solutions for operating system or hard drive crashes generally involve manual changing of drive/storage device connections, use of a restoration program stored on an external storage medium (e.g., floppy disc), or a combination of both procedures (see, for example, U.S. Pat. No. 6,175,904). Some of these processes can be tedious and time consuming and can require technical knowledge of the PC user. Accordingly, there is a need in the art for a rapid computer restoration product that is also simple to use and does not require the use of software during the restoring process.

### SUMMARY OF THE INVENTION

The present invention provides a novel computer system fitted with a recovery system that is activated by a switch and capable of rapidly restoring the computer to operational capacity after an operating system or hard drive crash.

The present invention also provides a novel of method of restoring a computer to operational capacity after an operating system or hard drive crash via a switch activated procedure.

The present invention also provides an switch operated apparatus that is capable of rapidly restoring a computer to operational capacity after an operating system or hard drive crash.

The present invention also provides a novel method of creating a cloned, bootable drive that can be used as a rescue drive.

### DETAILED DESCRIPTION

The present invention provides a novel computer fitted with a switch that is capable of restoring the computer when it has had an operating system or hard drive crash, and the corresponding method and apparatus for restoring. The actions taken by the user require no technical knowledge, no user made physical changes to the computer or its drives, or the use of software to restore the computer to operational capacity. Restoration is accomplished by the user activating a switch. Preferably, the computer is powered off, the switch is activated, and then the computer is powered on. The computer is then running in “rescue” mode. The rescue drive, which has now become the boot drive, preferably contains all pertinent programs and data that were on the original boot drive. Restoration preferably occurs within minutes of the crash. It is preferred that the rescue drive is a visible drive (e.g., can be seen in Windows Explorer®). It is also preferred that the data on the rescue drive can be seen and reviewed by a computer user.

While in rescue mode, the computer will generally not be protected by a rescue drive, since the original boot drive itself or the operating system thereon is defective and is not being used. This condition does not preclude the data on the now booted rescue drive from being protected by another drive (e.g., USB device, wireless hard disk, or other storage device). While in the rescue mode, the original rescue drive is now called the boot drive. Thus, it is preferred that the original boot drive, which is defective in some way, is either repaired or replaced such that it is a fully operational drive. The repaired or replaced drive can then be modified as described herein to become a new rescue drive.

When a PC is powered on, the first action is taken by the system BIOS (Basic Input Output System). This provides the basic instructions for a PC's hardware, and is coded into the computer's ROM (or Read Only Memory). One of the functions of BIOS is to locate the drive to which the computer will boot. The BIOS boot drive function is accomplished by pre-initialized parameters that tell the BIOS what kind of drive interface to use and which drive is the boot drive.

There are three types of drive interfaces to which the majority of currently available PC's boot: IDE/ATA/ATAPI/EIDE/ATA-2 (Intregrated Drive Electronics, Advanced Technology Attachment, Advanced Technology Attachment Packet Interface, and Enhanced or Expanded Integrated Drive Electronics, Advanced Technology Attachment-2 or Fast ATA), SCSI (Small Computer System Interface), and SATA (Serial Advanced Technology Attachment). In order to simplify the nomenclature of the present invention, IDE, as used herein, includes IDE, ATA, ATAPI, EIDE, and ATA-2 interfaces. In addition, the present invention is intended to be useful for any type of storage drive to which a computer boots. Other types of bootable drives, e.g., USB drives and firewire drives, while not being further discussed, are still considered to be part of the present invention.

The type of boot and rescue drives present will impact how the switch is connected to the computer and its drives. The overall function of the switch remains the same; to cause the computer to boot to the rescue drive. In general, for IDE and SCSI drives, the drive addresses are changed to that of the rescue boot drive preferably via electronic connections. In the case of SATA, the power to the drive is preferably used as the basis of boot selection. Alternatively, power supply selection can also be used to select the boot drive for IDE and SCSI interface types

The following examples assume the computer BIOS has been initialized to select that interface as the system boot interface.

IDE drives:

IDE controllers generally have two channels, each of which can support two hard drives; the Primary IDE channel can support a Master and a Slave hard drive and the Secondary IDE channel can support a Master and a Slave hard drive. Each IDE hard drive has a Jumper Block, which is read by the BIOS at power up. This information is used by BIOS to establish to which drive the computer will boot. The present invention makes the connections of the hard drive Jumper Block electrically, preferably by using electrical relays or by using electronic solid-state devices. The pattern of the connections made is determined by the switch of the present invention and the requirements of the drives. As a result, the present invention can be used for any connection pattern that is required to establish an IDE drive as the boot drive.

One embodiment of this could be two Western Digital hard drives connected to the Primary IDE channel of the IDE interface. With most of the Western Digital IDE drives, only one connection made on both hard drives' Jumper Blocks can set one drive as the Master and the second drive as the Slave. If hard drive 1 had no connections made at all on its Jumper Block and hard drive 2 had one connection made of the Slave pins (and BIOS is set for IDE Primary Master Boot) then hard drive 1 would be selected as the Master and would be the boot drive. In this case a simple double pole single throw, front mounted switch whose respective connections were connected to each of set of slave pins on the two hard drives could control which drive could be the boot drive and which could be the rescue drive. For the purposes of this example, both drives are duplicates, drive 1 is the boot drive (e.g., the normal working drive), and drive 2 is the rescue drive. During normal operation, or computing, a background computer program preferably makes regular timed data back ups to the second drive. Thus, in the event of a hard drive or operating system failure, the computer is powered off, the switch is activated, and then the computer is powered on and rebooted. Drive 2 will then be established as the boot drive. In this example, the user preferably sees little or no change in the operation of the computer.

In the case of IDE hard drives that require Jumper Block connections on both the Master and Slave jumper pins of the respective drives, the present invention can use coil operated relays, solid state relays, or solid state device connections to provide the connections of the respective drive which in turn set each drive as a Master or Slave. The switch can then activate the electrical or electronic circuitry that makes the appropriate Jumper Block connections.

SCSI drives:

SCSI boot selection is made by a SCSI BIOS. The main system BIOS drive interface is set to SCSI and then the SCSI BIOS boot drive selection is set to select the drive that will be the boot drive. Each SCSI drive has a drive address jumper block. Each SCSI drive must have a unique address, which is set with pin jumpers on the Identification Jumper Block. The addresses of most SCSI Identification Jumper Blocks range from 0, 1, 2, 3, 4, 5, 6, 7, 8, 9, 10, 11, 12, 13, 14, to 15 thus allowing the SCSI interface to uniquely identify each drive. The present invention seeks to change the SCSI address pins such that the selection electronics now control the identifier addresses of the applicable SCSI hard drives. The switch should allow the user to select the rescue drive settings in the case of a hard drive or operating system crash.

SATA drives:

SATA drives have no addressing electronics or BIOS settings that select the boot drive. Each drive is essentially a master drive. The boot drive is selected by which of the drives connected to the SATA interface is bootable. This means that normally only one drive of multiple hard drives is bootable. Preferably, the present invention could use the power to the SATA drives to allow and control multiple SATA boot drives on one computer. Since SATA drives are by design hot swappable, powering up a SATA drive after the computer is fully booted up, should cause the operating system to find and install that drive. This property of operating system drives detection and installation should be how the present invention could be able to install multiple boot drives on a SATA hard drive system.

The SATA hard drive that is the rescue bootable drive is powered off at system startup. The power lines (e.g., +12 and +5) are preferably connected to the SATA boot drives via relay or solid state devices. The control lines of the power control devices can then be activated and selected by the switch which powers up only the selected SATA boot drive when the computer is first powered on. Only after the computer is booted up is the rescue boot drives' power applied (and any additional boot drives). This could be accomplished by an output that controls the drive power control of the rescue boot drive. The output is activated by a software program that runs at startup. The output control is OR'D with all SATA boot drives. Because the system has been booted up, the powering up of the additional bootable drives can simply be added as “new hard drive found” by the operating system. The power control lines of all SATA hard drives should be activated thus not allowing the drive that was booted to be powered off by the user control. This prevents the user from turning off the main system drive inadvertently. However, when the computer is powered off, the switch is switched to rescue, and then the computer is powered back on, the rescue drive should then be powered on at start up. The remaining boot drives should be powered off until the system boots and the power on start up program runs setting the power control lines on, thus repeating the above sequence of powering on the remaining bootable SATA hard drives.

Software:

The software has two functions. The first part is the cloning or duplicating of the main boot drive. The second part is keeping the rescue drive, and/or other backup drive(s) or media, current.

Cloning/Duplicating:

The present invention can advantageously be used to back up one or more drives. The cloning/duplicating method will depend on whether one hard drive is present or two, three, four, or more hard drives are present. The ability of the present invention to copy multiple drives onto one single large drive, duplicate that drive, and then use the duplicated drive as a rescue drive is an advantage over currently available technology. It is noted that a cloning or duplicating doesn't necessarily mean that the cloned/duplicate drive is an exact or mirror image of the source drive. What is intended is that important subject matter on the source drive (e.g., operating system, programs, data) is duplicated. It is preferable that the computer's operator selects what information is to be duplicated. It is also preferred that a second or additional drive be installed in the computer prior to duplicating. The size of the second or additional drive will need to be at least as large as the amount of data to be duplicated or the sum of the drive space for which the new drive is to be a duplicate.

Method One (Computer with a Single Hard Drive):

In this case, preferably, the hard drive and its operating system are checked out to make sure the system is stable and there are no viruses present. Any updates are installed at this time and the system is preferably rechecked. Next, the system can then be re-booted and the cloning software run. The source or original hard drive can then be copied onto a second hard drive, the cloned or rescue drive. The preferred hard drive copying takes place outside of Windows® in a disk operating system. After the source hard drive has been copied and before any other action takes place, the computer can be powered off and the source hard drive removed from the computer. This can be accomplished by the power being removed from the source hard drive either manually by unplugging the power or by a more automated process using relays or solid-sate equipment. The rescue drive can now be set as the boot drive and the operating system can be booted up with the rescue drive. Next the system can be rechecked. After the rescue drive has been “seen” by the operating system, the rescue drive will function as if it were the original drive. Next the system can be shut down and the original drive installed and configured as it was originally. The rescue drive can then be set as a non-boot or second drive. The system can then be rebooted. The original operating system should now install the cloned drive as an additional hard drive. The newly installed cloned drive will have a new letter designation assigned which should be noted for the second phase of backup software. This new drive letter assignment may be changed.

The second phase of software is the installation of the backup software. This software runs in the background of the operating system on a timer interrupt. The backup software is selectively configured to copy any new data created by applications of the boot drive. Data to be backed up can be determined by the user or can be preset in the software itself. The backup software preferably has the ability to exclude unnecessary or potentially dangerous programs or files that could cause instability in the event of booting to the rescue drive.

Multiple Two (Computer with Multiple Hard Drives):

When more than one drive is present in the computer to be fitted with the present apparatus, then it is preferable to replace the multiple drives with two large drives, each having enough capacity to contain all of the information on the drives that are being replaced or having a capacity that is equal to the sum of the capacities of the drives being replaced. One of the large replacement drives will become the boot drive and the other the rescue drive. It is also preferable to partition each of the large replacement drives with the same number of partitions as drives that are being duplicated. For example, if there are four drives on the computer, then the replacement drives are preferably partitioned four ways.

In the case of a computer which has two hard drives and has no more resources available for another hard drive, a different technique is preferably used. An example of this would be a computer with a primary IDE channel supporting two hard drives (a primary master and a primary slave) and with the secondary IDE channel supporting two CD drives (secondary master CD and secondary slave CD). In this case, it is preferred that two new hard drives, each of which having a greater capacity than the sum of the original drives, will be installed. These two new hard drives will be referred to as big drive one (BD1) and big drive two (BD2). First, the IDE Primary Slave drive will be replaced by BD1, and the computer booted up, which will install BD 1. Next BD1 will be partitioned into two primary or logical partitions, partition one and partition two. Next the IDE Primary Master will be cloned into partition one of BD1. The computer will then be shut down. Primary Master drive will be replaced by BD1, and Primary Slave drive will be re-installed as Primary Slave. The computer will be restarted. After the system restarts and the Primary Slave has been reinitialized by the operating system, the Primary Slave drive will be cloned into partition two of BD1. Next the system will be shut down, and BD2 will replace the original Primary Slave drive. The computer will then be restarted to install BD2. BD2 will then be cloned from BD1. After which, both big drives will be identical and each have two partitions. Each partition one will be a clone of the original Primary Master, and each partition will be a clone of the original Primary Slave. BD2, which will now be set as the new Primary Slave, will then be mastered as described below to allow it to be the rescue drive.

For SCSI hard drives and interfaces, the dual method is applicable but not necessary since the hard dives are addressable and the interface typically supports up to fifteen drives.

For SATA hard drives and interface the dual drive installation and technique may be necessary. The method and technique that was used for IDE drives may essentially be used for SATA drives, with the addition of system start up software that adds the second boot drive.

The Mastering Process:

All of the above processes and techniques use a process that is applicable to all Microsoft Windows® products. Preferably, the above processes and techniques are useful for other operating systems as well (e.g., Linux). For the purposes of this invention this process will be called the Mastering Process. The Mastering Process is the procedure wherein the first computer action of the duplicated boot drive, which is to become the rescue drive, is to boot the computer as the root boot drive. This action forces the operating system on that hard drive to initialize any changes its operating system detects on that drive and establish those changes as new to that operating system with no operational differences to that system except for performance enhancements.

It is preferred that when the duplicated boot drive is first booted as the root boot drive, it takes the drive name designation of the original boot drive. (e.g., the c-drive in Windows®). Consequently, it is also preferable that when the switch is activated so as to make the rescue drive the bootable drive, the rescue drive takes the drive name designation of the original boot drive. It is also preferable that when the rescue drive takes the drive name designation of the original boot drive, the original boot drive then takes the drive name designation of the original rescue drive. For example, if the boot drive is seen as the c-drive and the rescue drive is seen as the d-drive, then it is preferred that when the switch is activated the rescue drive becomes the c-drive and the original boot drive becomes the d-drive. The preferred result is that when the switch is activated and the rescue drive becomes the boot drive, then all cloned or duplicated programs and data from the original boot drive are intact and operable.

One method of the Mastering Process for IDE drives is to power off the computer immediately after the original boot drive is duplicated. Next, the original hard drive power is removed and the duplicated, soon to be rescue, drive is set to Master. The computer is powered on with only the duplicated drive which causes the initialization process described above. The Mastering Process forces the duplicated drive to initialize its operating system with the same path and directory structure that the original drive(s) used when in the presence of the original drive(s) when both (all) drives exist in the same computer system. This process is essentially the same for SCSI and SATA drives.

The Selective Backup Software:

The present invention uses a backup software program which runs at preset timed intervals. The backup software backs up (e.g., copies) pre-selected files and directories of the boot drive (e.g., main working drive or drives) to the same or other file and directory locations of the rescue drive and or other storage locations, local or remote. Data files from the source directories are filtered for unwanted files and then compared; using the last write times of the source files, to that of the files of the destination directory. There are typically two resource files the backup software uses. First is a file that contains the source and destination directories. Second is a file that contains a list of alpha-numeric strings which are used to filter for files that are not to be backed up. The purpose of the selectivity and filtering of the backup program is to maintain the stability of the rescue drive. This insures an important aspect of the present invention: that the duplication of the original working system drive is performed at a time of known stability and tested state and that this state will remain stable as long as files that can produce instability are not introduced.

Storage device and drive are used herein interchangeably. They are intended to mean a medium to which a computer can write, store, and retrieve data and to which a computer can be instructed to boot. The boot drive, as used herein, is a storage device to which the computer initially boots. For example, the boot drive can be a hard drive of a computer. The rescue drive is a storage device capable of being the boot drive, but to which the computer does not currently boot. For example, the rescue drive can be a second, third, fourth, or more hard drive of a computer. Neither the boot nor the rescue drives are necessarily fixed into the computer as a hard drive. They are simply storage devices as defined previously.

Switch, as used herein, is intended to mean an apparatus that has the ability to send a signal which will cause the computer to change its boot drive configuration (e.g., boot to the rescue drive). Preferably, the switch is located external to the computer with which the switch is connected (e.g., outside of the container housing the computer). More preferably, the switch is visibly located on the computer itself or at a distance from the computer. Even more preferably, the switch is located on the computer case or cover, still more preferably on the outside top, front, sides, or rear. Preferably the switch has at least a first and second position (e.g., on vs. off or resting vs. depressed) and more preferably just a first and second position. Changing the device from one position to another (e.g., from the first to second, second to first, or depressing a button) activates the recovery procedure of the present invention. The switch can be mechanically or remotely connected to the computer to which it is associated. Examples of switches include, but are not limited to, toggles, push buttons, sliding levers, knobs, dials, number pads (physical and electronic), and locks requiring a key to change positions (e.g., key activated switches). The switches of the present invention could also be activated by non-mechanical actions. Examples of these types of switches include, but are not limited to; switches activated by sound, light (e.g., infrared), radio waves, internet communication, or some other computer or electronically generated activation. Preferred switches include double pole single throw switches and key activated switches.

Operational capacity, as used herein, refers to the computer being in a stable state and functioning. A stable state and functioning includes, for example: the computer being able to be powered on and off; the operating system running; a user being able to open and close programs and files; programs being able to be run as designed; and data being able to be read, moved, and saved.

Operating system or hard drive crash, as used herein, covers any type of malfunction or defect of a computer's operating system or hard drive that prevents it from being in an operational capacity. Malfunctions and defects, include, but are not limited to, mechanical failure of a drive or corruption of a drive or operating system caused by software problems and/or computer viruses.

Although several embodiments of the present invention and its advantages have been described in detail, it should be understood that changes, substitutions, transformations, modifications, variations, permutations, and alterations may be made therein without departing from the teachings of the present invention or the spirit and scope of the invention being set forth by the appended claims.

1. A computer system, comprising:
(a) a central processing unit (CPU),
(b) a memory,
(c) an operating system executing between the CPU and memory,
(d) a boot drive,
(e) a rescue drive, and
(f) an switch;
wherein the switch, upon activation, is capable of causing the computer to boot to the rescue drive.

2. The computer system of claim 1, wherein the switch is an external switch.

3. The computer system of claim 1, wherein the switch is a key activated switch.

4. The computer system of claim 1, wherein the boot and rescue drive interfaces are IDE interfaces.

5. The computer system of claim 4, wherein the switch is connected to the slave pins of the IDE interfaces.

6. The computer system of claim 4, wherein the switch is connected to the slave and master pins of the IDE interfaces.

7. The computer system of claim 4, wherein the switch is a double pole single throw switch.

8. The computer system of claim 1, wherein the boot and rescue drive interfaces are SCSI interfaces.

9. The computer system of claim 8, wherein the switch controls the identifier addresses of the SCSI interfaces.

10. The computer system of claim 1, wherein the boot and rescue drives are SATA drives.

11. The computer system of claim 10, wherein the switch controls the power to the SATA drives.

12. The computer system of claim 1, wherein the rescue drive is a duplicate of the boot drive.

13. The computer system of claim 12, wherein the rescue drive is booted once as the boot drive prior to its designation as the non-boot, rescue drive.

14. The computer system of claim 13, wherein the rescue drive is formed by the process, comprising:
(a) duplicating the boot drive,
(b) booting the computer to the duplicated drive,
(c) rebooting the computer to the boot drive, and
(d) designating the duplicated drive as the non-boot, rescue drive.

15. The computer system of claim 14, wherein when the duplicated drive is booted to the computer, it takes the drive designation name of the original boot drive.

16. The computer system of claim 12, wherein changes made to the boot drive are correspondingly made to the rescue drive at timed intervals.

17. The computer system of claim 15, wherein the timed intervals are adjustable.

18. The computer system of claim 15, wherein a computer user can select which changes made to the boot drive should also be made to the rescue drive.

19. The computer system of claim 1, wherein when the switch is activated the rescue drive takes the drive name designation of the boot drive.

20. The computer system of claim 19, wherein when the rescue drive takes the drive name designation of the boot drive, the boot drive then takes the previous drive name designation of the rescue drive.

21. A method of creating a cloned, bootable drive, comprising:
(a) duplicating a computer's boot drive onto a second drive,
(b) booting the computer to the second drive, and
(c) rebooting the computer to the boot drive.

22. The method of claim 21, further comprising:
(d) designating the second drive as a non-boot, rescue drive.

23. The method of claim 22, wherein when the computer is booted to the rescue drive, the rescue drive takes the drive designation name of the original boot drive.

24. The method of claim 23, wherein when the computer is booted to the rescue drive, and the rescue drive takes the drive designation name of the original boot drive, then the original boot drive takes the drive designation name of the original rescue drive.

25. A method of restoring a computer to operational capacity, comprising: activating a switch, wherein activating the switch causes the computer to readdress its hard drive configuration by changing the computer's boot order from the original boot drive to a rescue drive.

26. The method of claim 25, wherein the switch is an external switch.

27. The method of claim 25, wherein the rescue drive is formed by the process, comprising:
(a) duplicating the boot drive,
(b) booting the computer to the duplicated drive,
(c) rebooting the computer to the boot drive, and
(d) designating the duplicated drive as the non-boot, rescue drive.

28. The method of claim 27, wherein when the duplicated drive is booted to the computer, it takes the drive designation name of the original boot drive.

29. The method of claim 25, wherein when the computer is booted to the rescue drive, the rescue drive takes the drive designation name of the original boot drive.

30. The method of claim 29, wherein when the computer is booted to the rescue drive, and the rescue drive takes the drive designation name of the original boot drive, then the original boot drive takes the drive designation name of the original rescue drive.

31. The method of claim 25, wherein the computer is powered off prior to activating the switch and then powered on after the switch has been activated.
